(19) United States
(12) Patent Application Publication
(10) Pub. No.: US 2009/0271921 A1
(43) Pub. Date: Nov. 5, 2009

(54) USER-SYSTEM INTERFACE FOR TUBS

(76) Inventor: Miguel A. CASTELLOTE, Sainte-Marguerite-de-Dorchester (CA)

Correspondence Address: OGILVY RENAULT LLP, 1, Place Ville Marie, SUITE 2500, MONTREAL, QC, H3B 1R1, CA

(21) Appl. No.: 12/421,218

(22) Filed: Apr. 9, 2009

Related U.S. Application Data
(60) Provisional application No. 61/043,901, filed on Apr. 10, 2008.

(51) Int. Cl. A61H 33/00

(52) U.S. Cl. 4/541.1

(57) ABSTRACT

A user-system interface actuates a tub system associated with the tub comprising a tub wall with an opening in the tub wall above a maximum water level of the tub. A screen plate is mounted to the tub wall to cover the opening, the screen plate having keys representing functions of the tub system, and being made of a material allowing visible light/infrared radiations to pass therethrough. Sensors are associated with each one of the keys of the screen plate through the opening in the tub wall and concealed from a visible surface of the tub, the sensors being triggered by electromagnetic radiations of a user across a respective one of the keys. A controller receives actuation signals from the a triggered one of the sensors to actuate any selected function of the tub system.

### CROSS REFERENCE TO RELATED APPLICATION

This patent application claims priority on U.S. Provisional Patent Application No. 61/043,901, filed on Apr. 10, 2008, by the present applicants.

### FIELD OF THE APPLICATION

The present application relates to tub systems such as jet massage systems, magnetotherapy systems, aromatherapy systems, foot-massage systems, heating systems and the like used in tubs (i.e., bathtubs, hot tubs, whirlpools and similar basins), and more particularly to a user-system interface to actuate these systems in tubs.

### BACKGROUND OF THE ART

Tubs are well known for their primary use, namely a washroom installation in which a user person washes and bathes. Tubs have, however, evolved to add relaxation and comfort to practicality, and are found in many forms, such as bathtubs, spas, whirlpools.

For instance, tubs are now provided with air-jet systems and whirlpool systems, by which air or water is injected into the water of the tub to create some turbulence in the water. The turbulence creates a massaging effect on the bather in the tub. Other types of electrically actuated systems, such as oxygenation systems, foot-massage systems and aromatherapy systems are provided in conjunction with tubs, whereby a plurality of treatments and physical/sensorial experiences are available with tubs. Such systems are often actuated through mechanical switches with normally-open contacts, which contacts are closed by the manipulation of the user.

Other types of systems have been developed to avoid the use of mechanical contacts. For instance, systems, using touchless or finger-sensitive technologies, which operate, based on capacitive field fluctuation. One drawback with such systems is their sensitivity to dielectric liquids, whereby they do not constitute an efficient solution for tub applications.

The bather having recourse to such treatments or physical/sensorial experiences seeks, amongst other things a moment of relaxation. It is therefore desired to simplify the use of all such systems to ensure that the bather benefits from relaxing in the tub.

### SUMMARY OF THE APPLICATION

It is therefore an aim of the present invention to provide a user-system interface for tubs addressing issues associated with the prior art.

Therefore, in accordance with the present application, there is provided a user-system interface for a tub system, comprising: a screen plate adapted to be mounted to a tub wall to cover an opening in the tub wall, the screen plate having keys representing functions of the tub system, and being made of a material allowing at least one of visible light and infrared radiations to pass therethrough; sensors associated with each one of the keys of the screen plate through the opening in the tub wall and concealed from a visible surface of the tub, the sensors being triggered by electromagnetic radiations reflected/emitted by a user across a respective one of the keys; and a controller receiving actuation signals from a triggered one of the sensors to actuate any selected function of the tub system.

Further in accordance with the present application, there is provided a user-system interface and tub assembly, the user-system interface for actuating a tub system associated with the tub, comprising: a tub comprising a tub wall with an opening in the tub wall above a maximum water level of the tub; a screen plate mounted to the tub wall to cover the opening, the screen plate having keys representing functions of the tub system, and being made of a material allowing at least one of visible light and infrared radiations to pass therethrough; sensors associated with each one of the keys of the screen plate through the opening in the tub wall and concealed from a visible surface of the tub, the sensors being triggered by electromagnetic radiations reflected/emitted by a user across a respective one of the keys; and a controller receiving actuation signals from the a triggered one of the sensors to actuate any selected function of the tub system.

### BRIEF DESCRIPTION OF THE DRAWINGS

FIG. 1 is an exploded view of a user-system interface for tubs in accordance with an embodiment of the present invention;

FIG. 2 is a block diagram of the user-system interface of FIG. 1;

FIG. 3 is a side elevation view of the user-system interface for tubs of FIG. 1;

FIG. 4 is an enlarged end view of the user-system interface for tubs of FIG. 1;

FIG. 5 is a perspective view of a screen plate of the user-system interface of FIG. 1; and

FIG. 6 is a sectional view of a casing of the user-system interface for tubs of FIG. 1.

### DESCRIPTION OF THE PREFERRED EMBODIMENTS

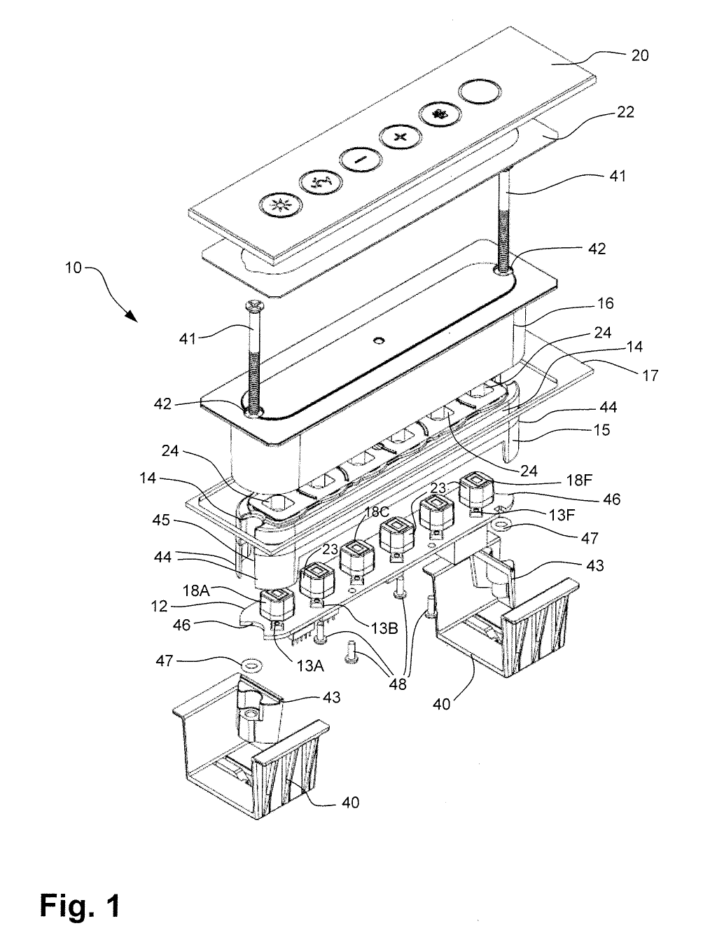

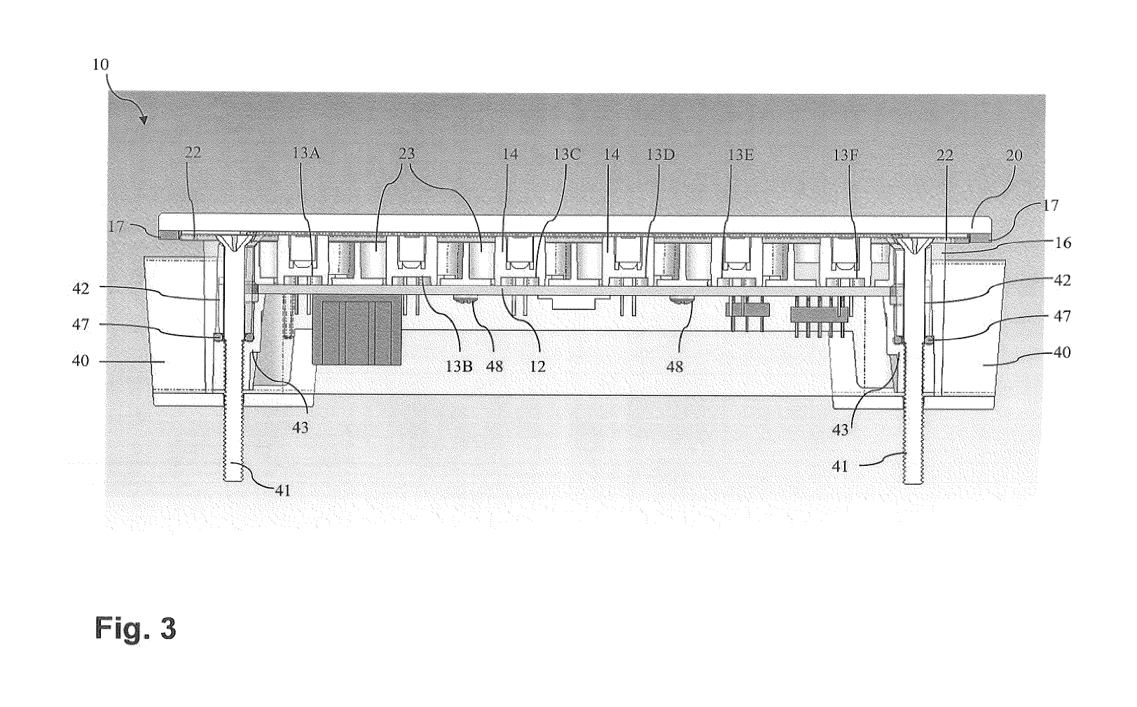

Referring now to FIGS. 1 and 3, a user-system interface for tubs in accordance with an embodiment is generally shown at 10. The user-system interface 10 is an interface between a tub user and a tub system, and has a circuit board 12 with light sources 13.(e.g., LEDs), optical guides 14 that are part of a spacer 15, a casing 16, a gasket 17, sensors 18, a screen plate 20, and a layer of adhesive 22.

The circuit board 12 has a microcontroller and circuitry, in addition to the light sources 13, so as enable the various functions performed by the user-system interface described hereinafter. In an embodiment, the sensors 18 are part of the circuit board 12, whereby the circuit board 12 is a sensor board. The sensors 18 are mounted atop supports 23. The supports 23 may be held captive to the circuit board 12, such that the angle and height of each sensor 18 is the same, when the sensors 18 are welded to the circuit board 12. This ensures uniform readings by the various sensors 18.

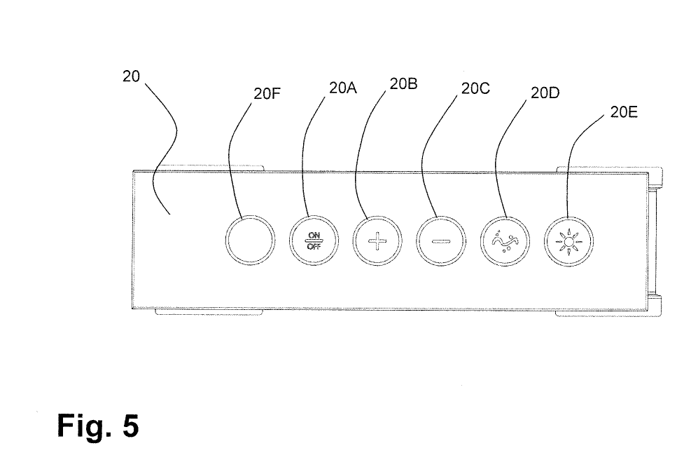

The optical guides 14 are placed between the circuit board 12 and the top translucent/transparent surface of a top wall of the casing 16, and ate provided to ensure uniform lighting of the keys of the screen plate 20 (e.g., avoid optical interference or optical crossing). The optical guides 14 will be described in further detail hereinafter. Light-emitting diodes (i.e., LEDS) are particularly well suited to be used in the user-system interface 10. In the illustrated embodiment, the light sources 13 are paired for each of the keys 20A-20F (FIG. 5.), but more or less LEDs can be used, as well as other types of light sources. FIG. 1 illustrates a light source having a pair of outputs 13F.

In an embodiment, the sensors 18 are infrared receivers or the like that are on the circuit board 12, or connected thereto. The infrared receivers 18 or like sensors are triggered by the proximity of an infrared emitting source, such as a finger of a user person, to actuate functions of a tub system associated with the system 10.

In another embodiment, the sensors 18 are emitters/receivers that emit electromagnetic radiations of a selected wavelength range, and that collect the beam reflected by the presence of an object in close proximity to the keys 20A-20F (FIG. 5), such as a finger. For instance, the emitters of the sensors 18 are infrared emitters.

As an alternative embodiment, the receivers are chosen to collect light from the light sources 13 that is reflected by the presence of an object in close proximity to the keys 20, such as a finger.

The casing 16 accommodates the circuit board 12, the spacer 15 and the sensors 18.

The screen plate 20 is mounted onto the top surface of the casing 16. The screen plate 20 has keys 20A, 20B, 20C, etc (FIG. 5). The keys are typically marked (e.g., screen-printed, engraved, stamped, pad printed to name a few of numerous possibilities) onto the screen plate 20 (e.g., on the undersurface of the screen plate 20), and are in register with the sensors 18A, 18B and 18C and with associated light sources 13 on the circuit board 12. The keys 20 represent symbols related to different functions of the tub system used with the user-system interface 10 (e.g., on/off, +/−, etc.). Considering that the sensors 18 used in the system 10 operate on proximity-detecting technology, the screen plate 20 is typically a simple flat plate of translucent or transparent material, or made of a material that allows selected wavelength ranges to pass therethrough (i.e., a material allowing light and/or infrared radiations, and potentially some UV radiation), whereby the keys each are a surface of the screen plate 20 in register with one of the sensors 18A to 18F so as to be sensitive to the presence of an object. Indicia or symbols delimit the sensitive surface forming the key. A paint or coating may be added to the screen plate 20 to filter out some given wavelengths.

As the keys 20A-20F (FIG. 5) may be selectively lit by the light sources 13 in a sequence to be described hereinafter, the screen plate 20 of the system 10 is optionally made of a transparent or translucent material (i.e., materials allowing light or selected wavelength ranges to pass through), to allow light to be seen through the keys 20A-20F (FIG. 5).

Referring to FIGS. 1 and 3, it is observed that the optical guides 14 each have a tubular portion 24. Therefore, the supports 23 are each concentrically positioned into a corresponding tubular portion 24, and preferably abut against an undersurface of the top wall of the casing 16. This defines two isolated optical paths for each of the optical guides 14. More specifically, when the casing 16 is positioned on the circuit board 12, the light sources 13 are between the supports 23 and the tubular portion 24, whereas the sensors 18 are on top of the tubular portions 24. This configuration is provided to avoid optical interference or optical crossing. The supports 23 and the tubular portions 24 preferably have a color well suited to reflect light, such as white.

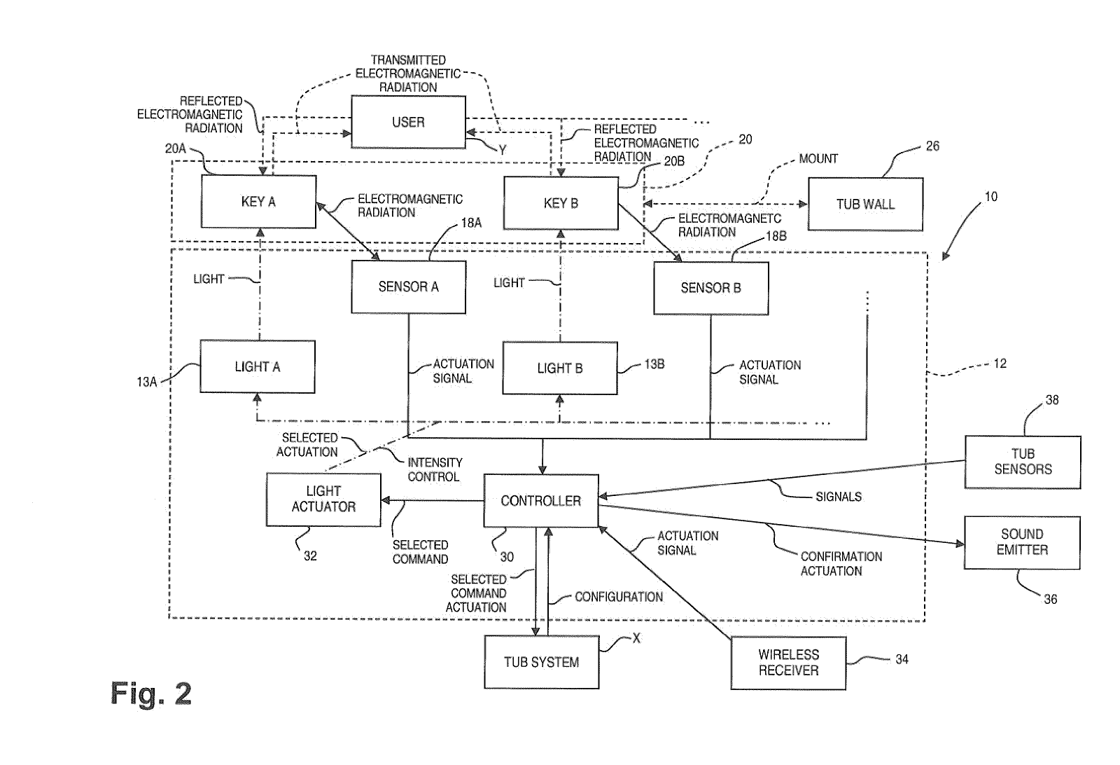

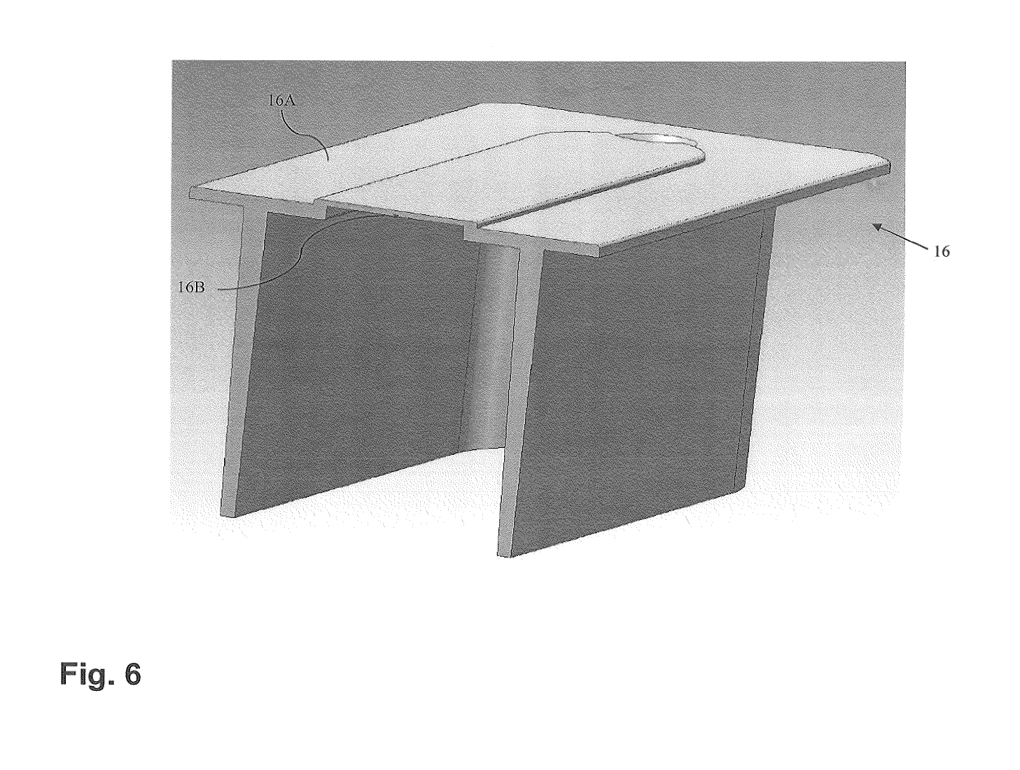

The screen plate 20 is secured to a top surface of the top wall of the casing 16, for instance using an adhesive layer 22 (e.g., VHB™ adhesive. Referring to FIG. 6, in order to account for the thickness of the adhesive layer 22, the top wall of the casing 16 preferably has a peripheral depression 16A on its top surface, and a channel 16B to house the supports 23. By this configuration, the casing 16 is directly in contact with the screen plate 20 on top of the sensors 18—there is no air gap. The adhesive layer 22 is preferably two-sided and waterproof, so as to define a waterproof layer between the casing 16 and the screen plate 20. The screen plate 20 being the interface between the user and the tub system, the screen plate 20 is typically embedded in a wall 26 of the tub, so as to be the only visible part of the user-system interface 10. The screen plate 20 is sealingly mounted to the tub wall 26 (FIG. 2) so as to avoid infiltration of water through a gap between the screen plate 20 and the tub wall 26. The gasket 17 may be used to provide additional visual appeal at the junction between the screen plate 20 and the tub wall 26.

Referring to FIG. 2, the user-system interface 10 is shown in greater details with respect to the circuit board 12 and components thereof.

The circuit board 12, in addition to the light sources 13 (illustrated as light sources 13A and 13B), has a controller 30. The controller 30 has a processing unit, so as to identify command actuations to send to the tub system X according to the user Y's selection, ensuring the logics and the commands of the user-system interface 10. More specifically, the controller 30 is connected to the sensors 18, of the circuit board 12 (FIG. 1), and has a sensor control unit to drive the emitters of the sensors 18 and receive actuation signals associated with the user Y's selection.

The controller 30 receives the signals and also has an interface unit to send appropriate command actuations to the tub system X (e.g., start, increase/decrease level, stop). Any appropriate protocol may be used between the controller 30 and the tub system X (e.g., I2C protocol, or the like). A signal is also sent to a light actuator 32.

In an embodiment, the light actuator 32 controls the lighting of the keys 20A, 20B, etc., according to the functions of the system 10. For instance, the system 10 is programmed to light up the keys 20 being triggered by the user Y, to confirm to the user Y that his/her selection has been received.

It may be desired to keep one or more light sources 13 lit, to indicate that the tub system X is operating. For instance, the light actuator 32 may keep an “ON” key (from the keys 20) lit when the tub system X is operating.

Alternatively, the light actuator 32 may actuate light sources 13 fore the options that are available. As an example, if the maximum intensity level of injecting air for the air massage tub system Y has been reached, the light associated with the “+”, key may be turned off while the light associated with the “−” key is kept on. In such a case, the symbols in the screen plate 20 (FIG. 1) may be hidden unless lit.

The light actuator 32 is also preferably programmed to vary the intensity of the light emitted by the light sources 13. For instance, the light sources 13 may always have some dim lighting, the intensity of which is increased to confirm a selection by the user Y. Again, in such a case, the symbols in the screen plate 20 (FIG. 1) may be hidden unless lit.

In an embodiment, the sensors 18 each have an emitter emitting specific electromagnetic radiations (e.g., infrared radiations), the emitted beams passing through the screen plate 20, being reflected by the finger of the user Y, back through the screen plate 20 for detection by receivers of the sensors 18, thereby creating an actuation signal to the controller 30.

In another embodiment, the sensors 18 are infrared receivers 18 that detect infrared emission from the fingers of the user Y. In this configuration, no emitter is required within the sensors 18. The user-system interface 10 is programmed to operate with either one of the infrared reflection, or the detection of infrared emission from a human body

In another embodiment, the sensors 18 detect light emitted by the light sources 13 and reflected by the finger of the user Y. In this case, the light sources 13 serve the dual function of backlighting the keys 20 and emitting light that will be reflected to trigger the sensors 18.

In the three embodiments described above, the controller 30 filters the actuation signal to ensure that the reflection detected by the receivers/sensors 18 is of suitable magnitude to represent an interaction from the user Y.

In another embodiment, the controller 30 is connected to a wireless receiver 34. The wireless receiver 34 receives commands from a remote control. The controller 30 sends corresponding command actuations to the tub system X, as well as selected commands to the light actuator 32. In such a case, the light actuator 32 preferably confirms the reception of the wireless signal by actuating the light sources 13 according to the above-described functions of the system 10. In such a case, it is considered to simplify the system by splicing the actuation line of the appropriate light source 13 to the command line sending a signal from the controller 30 to the tub system X.

In another embodiment, the controller 30 receives commands indirectly from the wireless receiver 34, by means of a tub system controller.

A sound emitter 36 is also optionally connected to the controller 30. The sound emitter 36 is actuated to confirm action by way of an audible signal to the user Y.

In another embodiment, tub sensors 38 are provided in order to operate the tub system X. For instance, the tub sensors 38 may be a water-sensing detector preventing actuation of some of the functions of the tub system X in the absence of water in the tub. The tub sensor 38 may also include a temperature sensor, to trigger the heating of the water in the tub.

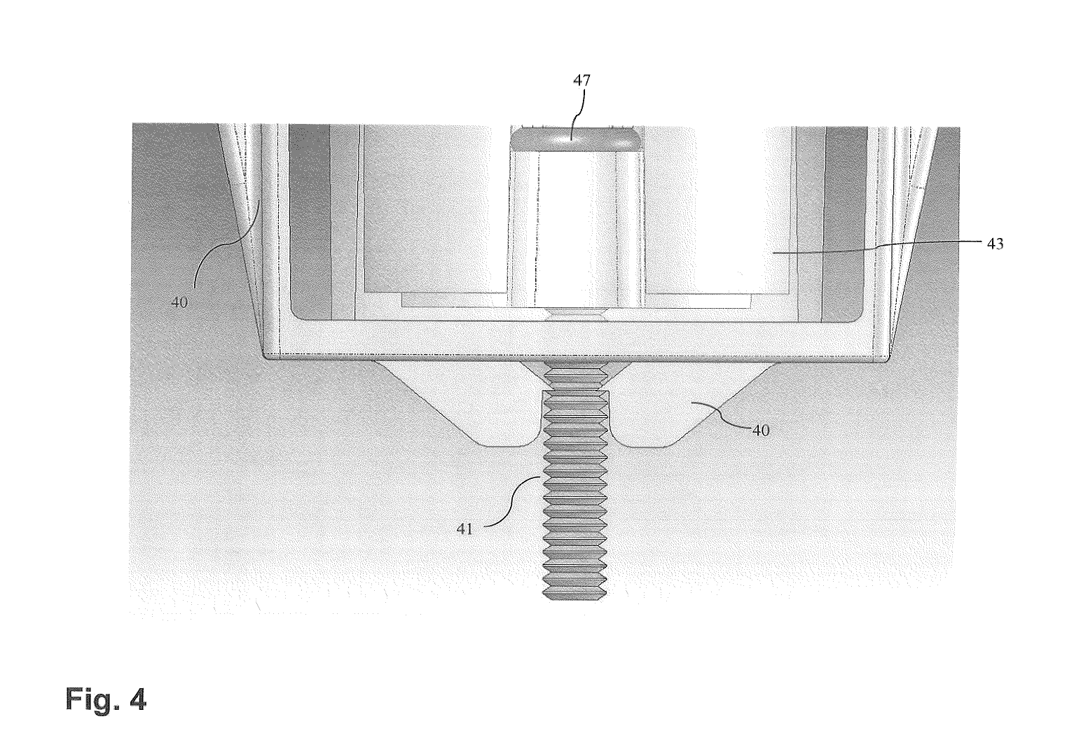

Referring to FIGS. 1 and 4, there is illustrated a configuration to secure the user-system interface 10 to the tub wall. Firstly, an opening is defined, in the tub wall, which opening has a smaller dimension than that of a flange defined by the top wall of the casing 16. Accordingly, the casing 16 is seated on the surface of the tub surrounding the periphery of the opening. Brackets 40 are used to structurally retain the casing 16 pressed against a hidden surface of the tub.

Fasteners such as bolts 41 are passed through tubular portions 42 in the casing 16, and are engaged into fingers in the brackets 40, as illustrated in FIG. 4. Accordingly, the brackets 40 are urged against the hidden surface of the tub as the bolts 41 advance into the brackets 40, in an indexing fashion, or alternatively, in a screwing engagement (not shown). The flange of the casing 16 and the brackets 40 press on opposed sides of the tub wall as a result of the screwing engagement of the bolts 41, thereby forming a structural connection.

Before this screwing engagement, the various other components are sandwiched between the casing 16 and the brackets 40. More specifically, connectors 43 are provided for each bolt 41, and align components of the user-system interface 10. The connectors 43 are partially accommodated in end legs 44 of the spacer 15. A channel 45 is defined at the end legs 44 such that the tubular portions 42 of the casing 16 may be in register with the connectors 43, whereby the fasteners 41 pass therethrough. Bevelings 46 are provided at opposed ends of the board 12 also to allow the bolts 41 to reach the connectors 43. O-rings 47 are provided to prevent water infiltration between the bolts 41 and the tubular portions 42; whereas bolts 48 may be used to secure the board 12 to the spacer 15. This configuration is one of numerous configurations considered to secure the user-system interface 10 to the tub.

Once the user-system interface 10 is secured to the tub wall, the screen plate 20 may be installed on top of the top wall of the casing 16, using the adhesive 22.

The user-system interface 10 is typically used with tub systems (a.k.a., apparatuses) such as jet massage system, foot-massage systems, aromatherapy systems, magnetotherapy systems, surface-heating systems, and other similar actuatable tub systems.

1. A user-system interface for a tub system, comprising:
a screen plate adapted to be mounted to a tub wall to cover an opening in the tub wall, the screen plate having keys representing functions of the tub system, and being made of a material allowing at least one of visible light and infrared radiations to pass therethrough;
sensors associated with each one of the keys of the screen plate through the opening in the tub wall and concealed from a visible surface of the tub, the sensors being triggered, by electromagnetic radiations emitted/reflected by a user across a respective one of the keys; and
a controller receiving actuation signals from a triggered one of the sensors to actuate any selected function of the tub system.

2. The user-system interface according to claim 1, wherein the sensors are infrared sensors.

3. The user-system interface according to claim 1, further comprising a casing accommodating the sensors and connected to an undersurface of the screen plate, the casing have a top wall opposite the screen plate, the top wall being made of a material allowing at least one of visible light and infrared radiation to pass therethrough.

4. The user-system interface according to claim 3, wherein a two-sided adhesive connects the top wall of the casing to the screen plate, and the top wall defines a peripheral depression to receive the adhesive such that the top wall of the casing and the undersurface of the screen plate are coplanar above the sensors.

5. The user-system interface according to claim 3, wherein the casing comprises a flange adapted to be seated on a surface of the tub wall about a periphery of the opening, the user-system interface further comprising at least one bracket under the tub wall, and fasteners mechanically connecting the casing to the at least one bracket such that the tub wall is sandwiched between the flange and the at least one bracket.

6. The user-system interface according to claim 3, further comprising a circuit board supporting the sensors and the controller for operation, the circuit board adapted to be connected to the tub system.

7. The user-system interface according to claim 6, wherein the sensors each have a support so as to project upwardly from the circuit board, whereby the sensors are against the top wall of the casing.

8. The user-system interface according to claim 7, wherein the sensors are welded directly to the circuit board to hold the supports captive against the circuit board, whereby the sensors are all at a same distance and orientation from the circuit board.

9. The user-system interface according to claim 3, further comprising a spacer accommodated in the casing and positioned between the top wall of the casing and the sensors, the spacer comprising a tubular portion for each of the sensors to define an optical path between keys of the screen plate and an associated one of the sensors.

10. The user-system interface according to claim 9, further comprising a circuit board supporting the sensors and the controller for operation, the circuit board adapted to be connected to the tub system.

11. The user-system interface according to claim 10, wherein the sensors each have a support so as to project upwardly from the circuit board and through the tubular portions, whereby the sensors are against the top wall of the casing.

12. The user-system interface according to claim 11, further comprising at least one light source for each of the sensors to backlight the keys in the screen plate, the light source being positioned between the tubular portion and the support.

13. The user-system interface according to claim 1, further comprising infrared emitters positioned in register with the keys of the screen plate and concealed from a visible surface of the tub, so as to emit electromagnetic radiations through the keys, whereby the sensors are triggered by electromagnetic radiations reflected by a user through a respective one of the keys.

14. A user-system interface and tub assembly, the user-system interface for actuating a tub system associated with the tub, comprising:
a tub comprising a tub wall with an opening in the tub wall above a maximum water level of the tub;
a screen plate mounted to the tub wall to cover the opening, the screen plate having keys representing functions of the tub system, and being made of a material allowing at least one of visible light and infrared radiations to pass therethrough;
sensors associated with each one of the keys of the screen plate through the opening in the tub wall and concealed from a visible surface of the tub, the sensors being triggered by electromagnetic radiations reflected/emitted by a user across a respective one of the keys; and
a controller receiving actuation signals from the a triggered one of the sensors to actuate any selected function of the tub system.

15. The assembly according to claim 14, wherein the sensors are infrared sensors.

16. The assembly according to claim 14, further comprising a casing accommodating the sensors and connected to an undersurface of the screen plate, the casing have a top wall opposite the screen plate, the top wall being made of a material allowing at least one of visible light and infrared radiation to pass therethrough.

17. The assembly according to claim 16, wherein the casing comprises a flange seated on a surface of the tub wall about a periphery of the opening, the user-system interface further comprising at least one bracket under the tub wall, and fasteners mechanically connecting the casing to the at least one bracket such that the tub wall is sandwiched between the flange and the at least one bracket.

18. The user-system interface according to claim 14, further comprising a spacer accommodated in the casing and positioned between the top wall of the casing and the sensors, the spacer comprising a tubular portion for each of the sensors to define an optical path between keys of the screen plate and an associated one of the sensors.

19. The user-system interface according to claim 18, further comprising a circuit board supporting the sensors and the controller for operation, the circuit board adapted to be connected to the tub system.

20. The user-system interface according to claim 19, wherein the sensors each have a support so as to project upwardly from the circuit board and through the tubular portions, whereby the sensors are against the top wall of the casing, the supports being welded directly to the circuit board, such that the sensors are all at a same distance and orientation from the circuit board.
